(19) United States
(12) Patent Application Publication
(10) Pub. No.: US 2013/0319191 A1
(43) Pub. Date: Dec. 5, 2013

(54) Methods and a Die for Forming an Indicia Groove on a Hand Tool and a Hand Tool with an Indicia Groove

(71) Applicant: Bobby Hu, Taichung (TW)

(72) Inventor: Bobby Hu, Taichung (TW)

(21) Appl. No.: 13/787,908

(22) Filed: Mar. 7, 2013

(30) Foreign Application Priority Data
Jun. 1, 2012 (TW) 101119776

(51) Int. Cl. B26D 3/06; B25G 1/10

(52) U.S. Cl. CPC B26D 3/06; B25G 1/10
USPC 81/489; 83/875

(57) ABSTRACT

A method for forming an indicia groove includes preparing an indicia die having a pressing face. A protruded indicia portion is formed on the pressing face and includes an upper face having a boundary. A protrusion is formed on the upper face and located in the boundary. A stepped portion is formed between the protrusion and the protruded indicia portion. The indicia die presses against a surface of a product, forming an indicia groove in the surface of the product. The indicia groove provides an indicating function for the product. The product with the indicia groove is obtained after removing the indicia die.

### BACKGROUND OF THE INVENTION

The present invention relates to methods and a die for forming an indicia groove on a hand tool and, more particularly, to methods for forming an indicia groove to press a letter, a pattern, or a figure on a rigid hand tool. The present invention also relates to a hand tool with a clear indicia groove.

With reference to FIG. 14, a currently available indicia die 8 for forming an indicia groove on a hand tool includes a pressing face 81. A protruded indicia portion 82 is formed on the pressing face 81 and includes an upper face 821 having a boundary 822. In the example shown in FIG. 14, the upper face 821 and the boundary 822 of the protruded indicia portion 82 together define a capital W.

The indicia die 8 is mounted on a pressing machine, with the pressing face 81 facing a surface 91 of a hand tool 9 (FIG. 15). The pressing machine applies a force to press the indicia die 8 against the surface 91 of the hand tool 9, generating an indicia groove 92 through plastic deformation. The indicia groove 92 is W-shaped in cross section to provide an indicating effect. The indicia groove 92 defines three intermediate portions 911 on the surface 92 of the hand tool 9. The intermediate portions 911 deform while the indicia die 8 presses against the surface 91 of the hand tool 9 to form the indicia groove 92, such that a face of each intermediate portion 911 is spaced from the surface 91 of the hand tool 9 (see deformation T3 in FIG. 16). A W-shaped indicia groove 92 is formed on the hand tool 9 after removal of the indicia die 8, as shown in FIG. 15.

However, a spacing L3 between a bottom face 921 of the indicia groove 92 and each intermediate portion 911 in the depth direction is small and, thus, can not provide a clear indication. Namely, the word W is not clear. Furthermore, after a period of time of use of the hand tool 9, the letter W defined by the indicia groove 92 becomes vague due to wear. Further, in a case that a paint is filled into the indicia groove 92 for coloring purposes, the sections of the intermediate portions 911 close to the indicia groove 92 are apt to be colored by the paint, failing to provide a contrast to the surface 91 of the hand tool 9.

Thus, a need exists for a novel indicia die to mitigate and/or obviate the above disadvantages.

### BRIEF SUMMARY OF THE INVENTION

The present invention solves this need and other problems in the field of reliable driving devices with magnetic attraction by providing, in a first aspect, a method including preparing an indicia die having a pressing face. A protruded indicia portion is formed on the pressing face and includes an upper face having a boundary. A protrusion is formed on the upper face and located in the boundary. A stepped portion is formed between the protrusion and the protruded indicia portion. A product is prepared, and the indicia die presses against a surface of the product, forming an indicia groove in the surface of the product. The indicia groove provides an indicating function for the product. The product with the indicia groove is obtained after removing the indicia die.

In a second aspect, an indicia die includes a pressing face. A protruded indicia portion is formed on the pressing face. The protruded indicia portion includes an upper face having a boundary. A protrusion is formed on the upper face and located in the boundary. A stepped portion is formed between the protrusion and the protruded indicia portion.

In a third aspect, a hand tool includes an indicia groove formed in a surface thereof. The indicia groove includes a bottom face and a lower face. The lower face is located between the bottom face and the surface of the product. The indicia groove has a height difference between the bottom face and the lower face. The indicia groove provides an indicating function for the hand tool.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a block diagram showing a method for forming an indicia groove according to the present invention.

FIG. 2 shows a perspective view of an indicia die according to the present invention.

FIG. 3 shows a perspective view of a portion of a hand tool and two indicia dies according to the present invention.

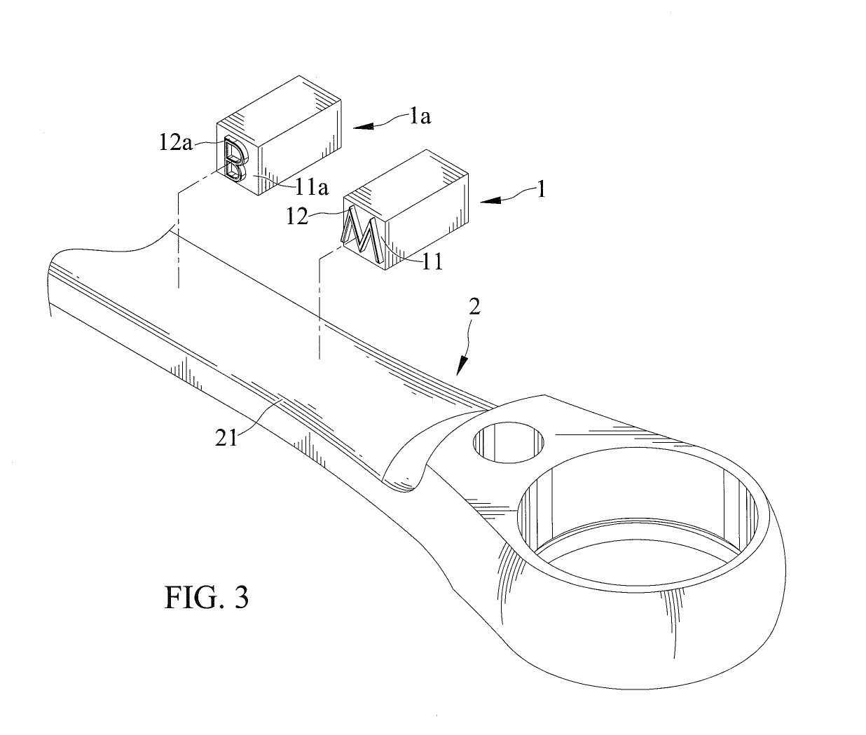

FIG. 4 shows an enlarged, cross sectional view of a product and one of the indicia dies of FIG. 3 before pressing.

FIG. 5 shows a view similar to FIG. 4, with a top face of the indicia die pressing against a surface of the product to form a bottom face of an indicia groove.

FIG. 6 shows a view similar to FIG. 5, with an upper face of a protruded indicia portion of the indicia die pressing against the surface of the hand tool to form a lower face of the indicia groove.

FIG. 7 shows a view similar to FIG. 3, with the indicia dies removed from the hand tool after pressing.

FIG. 8 is a perspective view of a product of the hand tool with two indicia grooves.

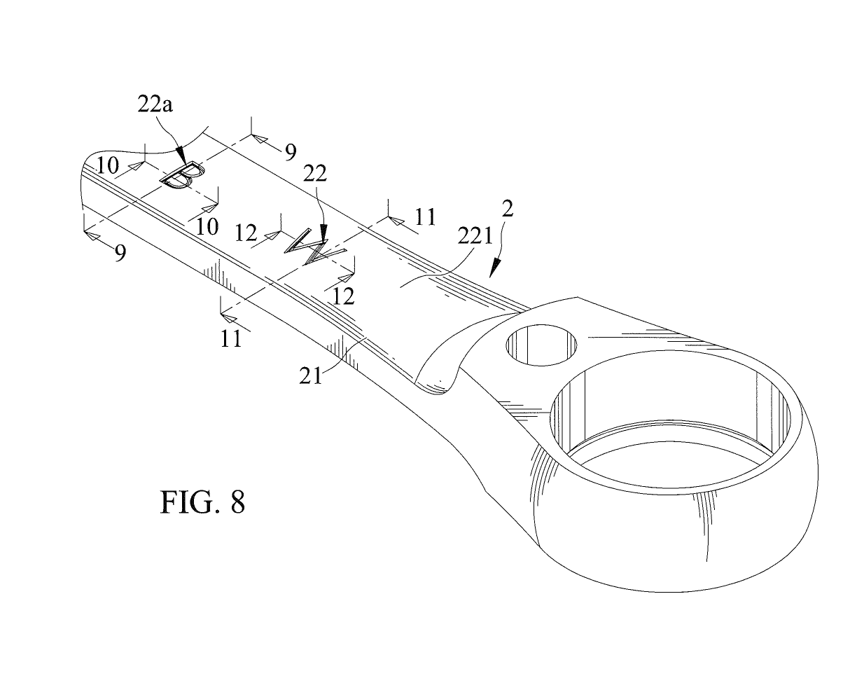

FIG. 9 is a cross sectional view taken along section line 9-9 of FIG. 8.

FIG. 10 is a cross sectional view taken along section line 10-10 of FIG. 8.

FIG. 11 is a cross sectional view taken along section line 11-11 of FIG. 8.

FIG. 12 is a cross sectional view taken along section line 12-12 of FIG. 8.

FIG. 13 is an enlarged view of a portion of the product of FIG. 8.

FIG. 14 shows a perspective view of a conventional indicia die.

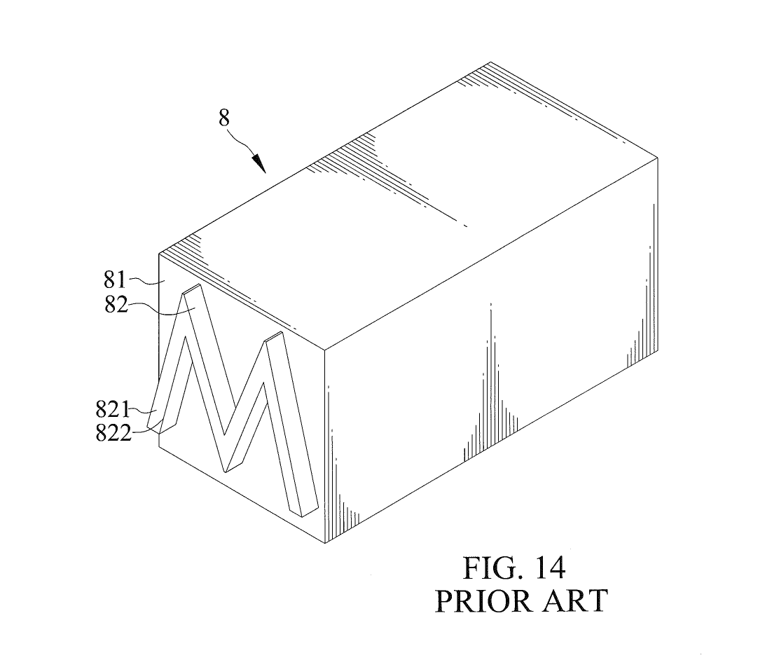

FIG. 15 shows a portion of a hand tool having an indicia groove formed by using the indicia die of FIG. 14.

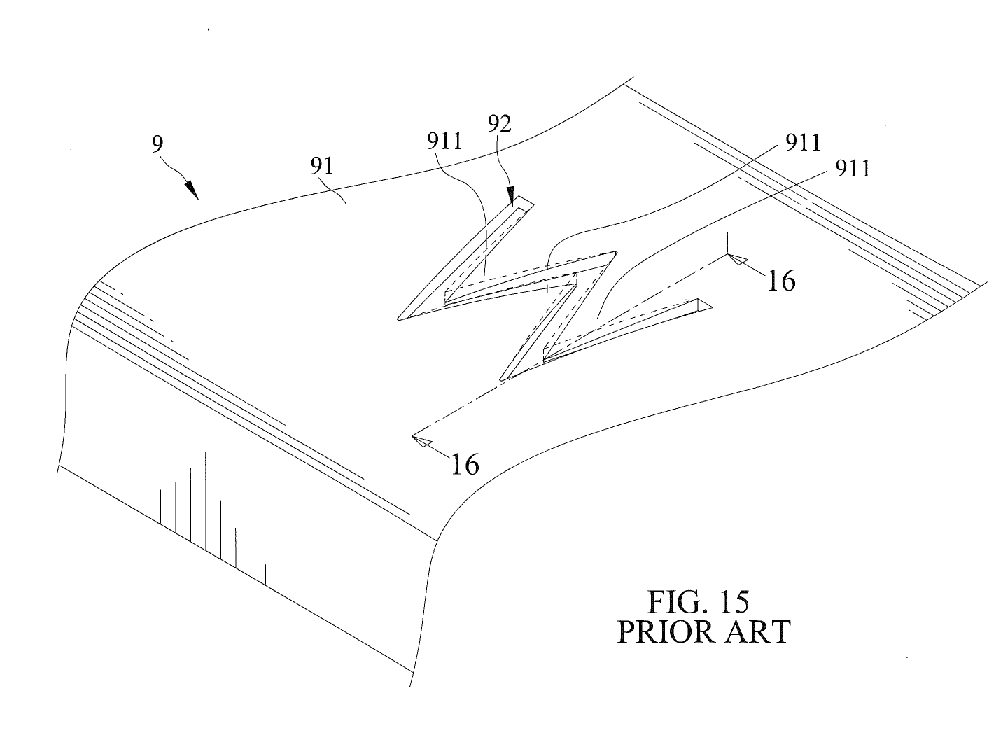

FIG. 16 is a cross sectional view taken along section line 16-16 of FIG. 15.

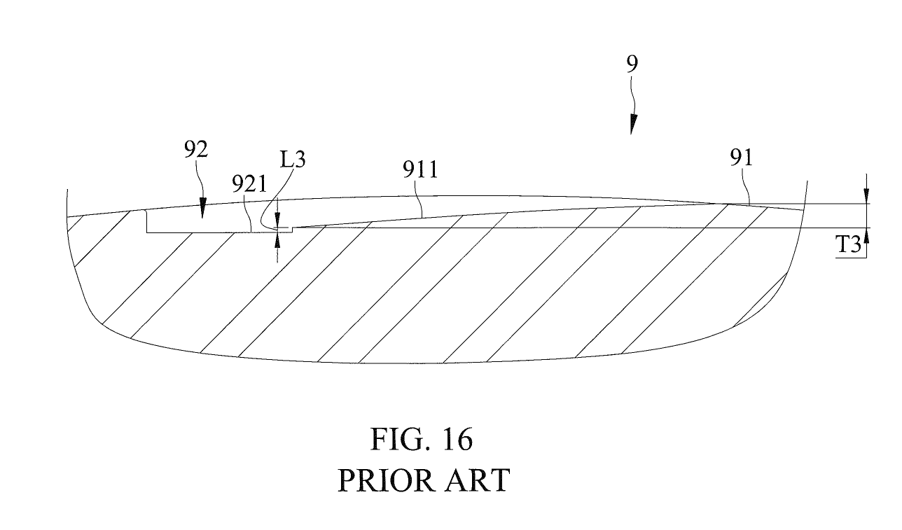

All figures are drawn for ease of explanation of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “portion”, “section”, “spacing”, “height”, “width”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

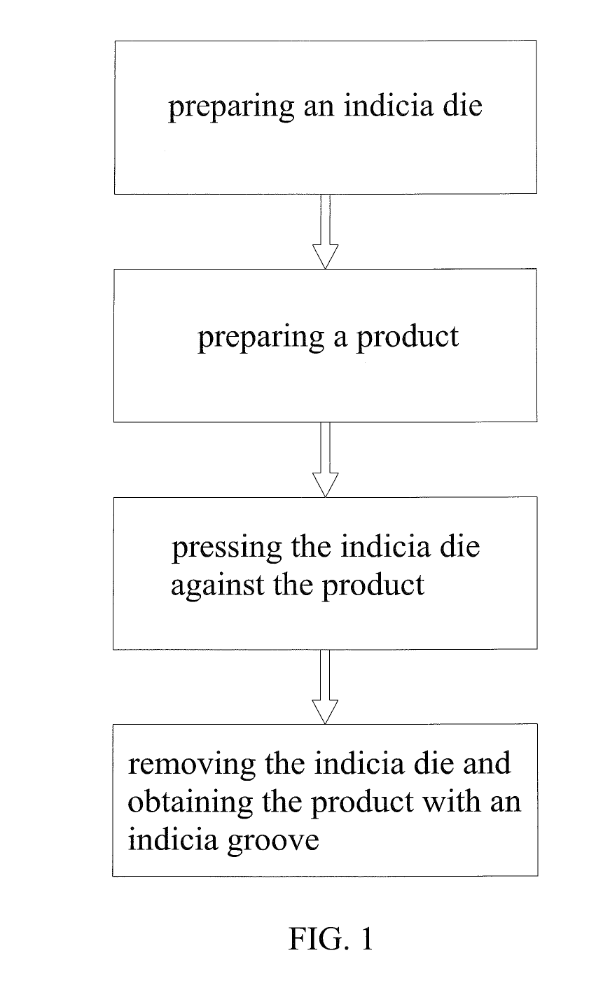

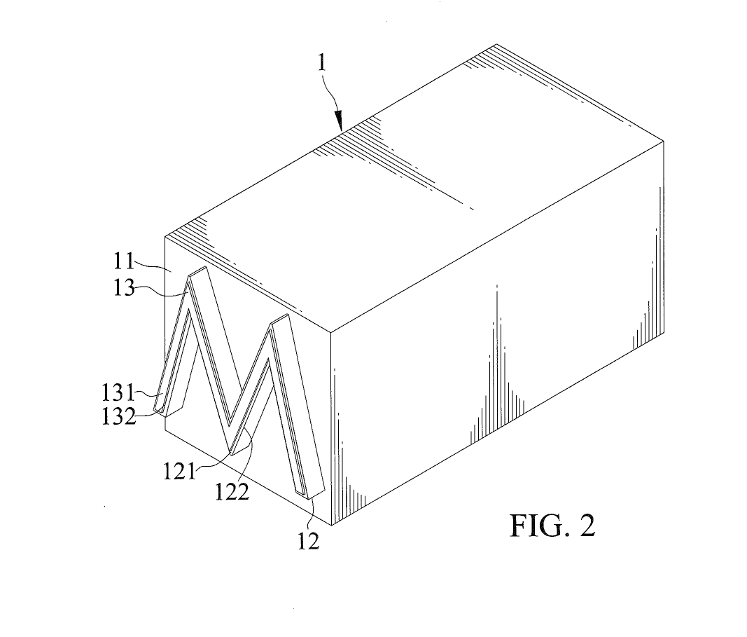

FIG. 1 is a block diagram showing a method for forming an indicia groove according to the present invention. The method includes preparing an indicia die 1. It can be appreciated that more than one indicia die can be prepared for more than one indicia grooves. In the form shown in FIG. 2, two indicia dies 1 and 1a are prepared. Each indicia die 1, 1a includes a pressing face 11, 11a. A protruded indicia portion 12, 12a is formed on the pressing face 11, 11a and includes an upper face 121, 121a having a boundary 122, 122a. A protrusion 13, 13a is formed on the upper face 121, 121a and located in the boundary 122, 122a. A stepped portion is, thus, formed between the protrusion 13, 13a and the protruded indicia portion 12, 12a. The protrusion 13, 13a includes a top face 131, 131a having a periphery 132, 132a. A first height H1 between the upper face 121, 121a of the protruded indicia portion 12, 12a and the pressing face 11, 11a in a height direction perpendicular to the pressing face 11, 11a is smaller than a second height H2 between the top face 131, 131a and the pressing face 11, 11a in the height direction. The boundary 122, 122a of the protruded indicia portion 12, 12a has a first width W1 perpendicular to the height direction. The periphery 132, 132a of the protrusion 13, 13a has a second width W2 perpendicular to the height direction. The first width W1 is larger than the second width W2. In the form shown, the second width W2 is larger than a half of the first width W1. The top face 131 and the periphery 132 of the indicia die 1 together define a capital W. The top face 131a and the periphery 132a of the indicia die 1a together define a capital B.

A product 2 to be pressed is prepared. In the form shown, the product 2 is a hand tool.

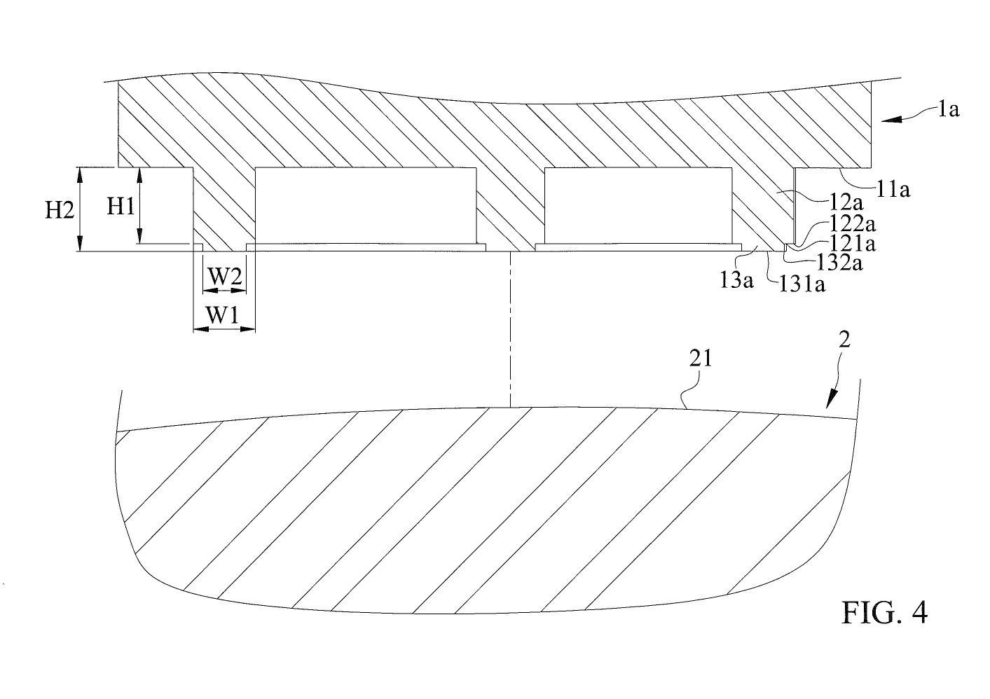

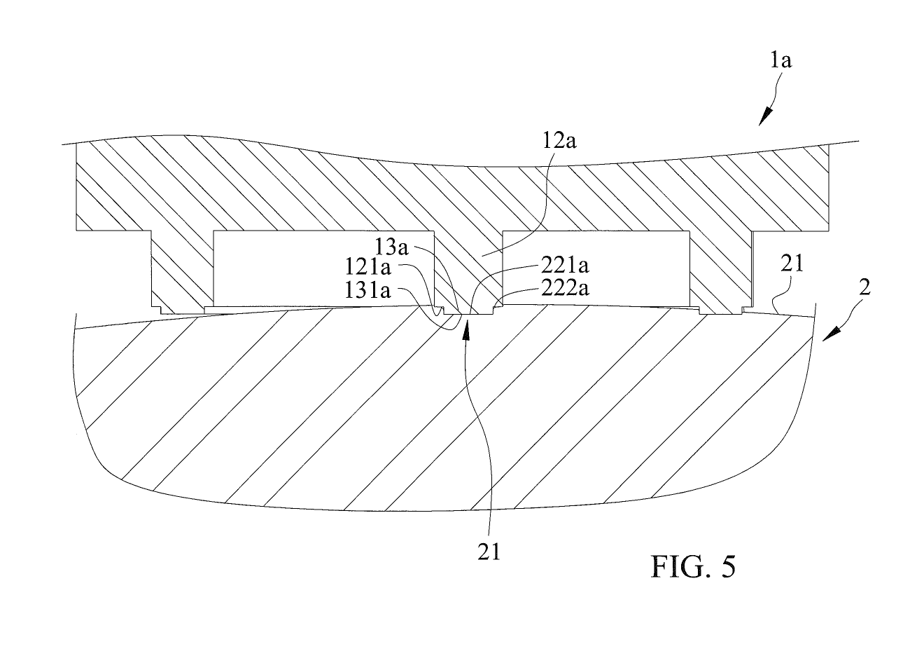

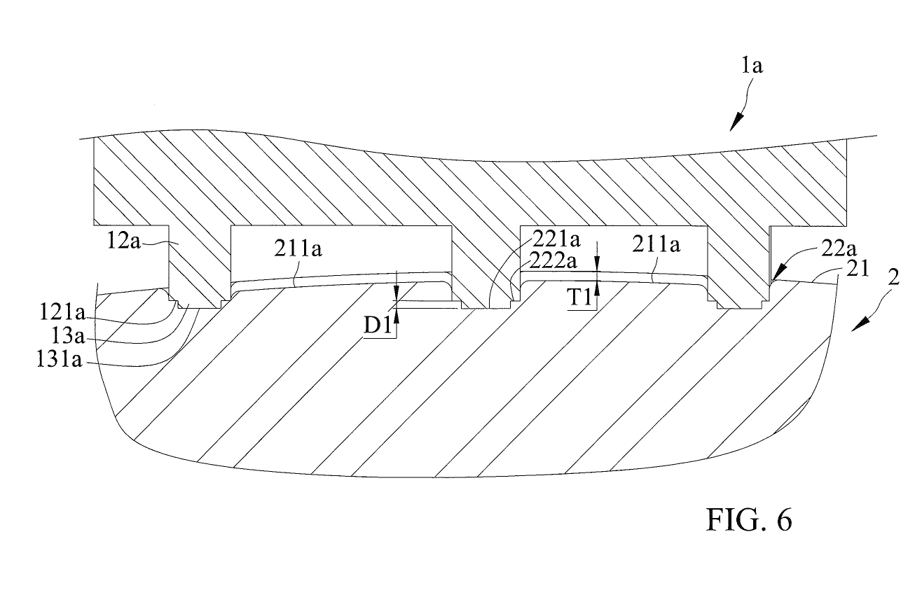

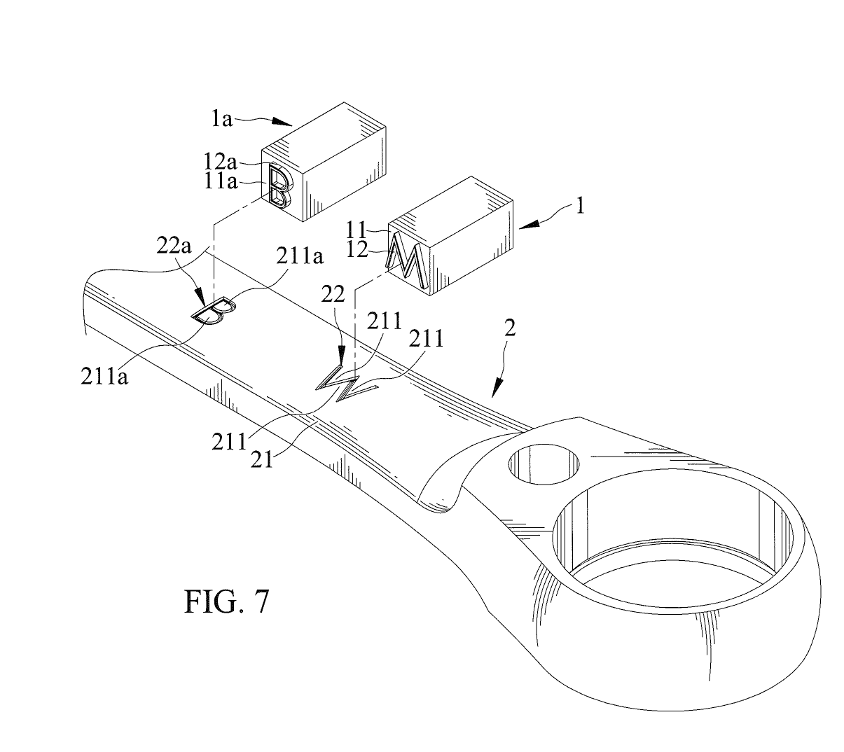

With reference to FIGS. 4-7, the indicia dies 1 and 1a are mounted to a pressing machine, with the pressing faces 11 and 11a facing a surface 21 of the product 2. The pressing machine applies a force to the indicia dies 1 and 1a to press against the surface 21 of the product 2, causing plastic deformation of the product 2. Two indicia grooves 22 and 22a are formed in the surface 21 of the product 2 and are respectively W-shaped and B-shaped to provide an indicating function for the product 2.

Since the pressing operations of the indicia dies 1 and 1a are identical, only the pressing operation of the indicia die 1a will be set forth. Since the second height H2 is larger than the first height H1, the top face 131a of the protrusion 13a of the indicia die la presses against the surface 21 of the product 2 first. A bottom face 221a of the indicia groove 22a and the top face 131a of the protrusion 13a press against each other. The indicia die 1a keeps pressing against the product 2, and the upper face 121a of the protruded indicia portion 12a of the indicia die 1a presses against the surface 21 of the product 2. Thus, the indicia groove 22a is formed with a lower face 222a. The lower face 222a and the upper face 121a of the protruded indicia portion 12a presses against each other. The lower face 222a is located between the bottom face 221a and the surface 21 of the product 2 in the height direction. Thus, the indicia groove 22a has a height difference D1 between the bottom face 221a and the lower face 222a. The indicia groove 22a includes a plurality of sections. The sections of the indicia groove 22a define two intermediate portions 211a on the surface 21 of the product 2. A face of each intermediate portion 211 a is spaced from the surface 21 of the product 2. Specifically, a spacing L 1 between the bottom face 221 a of the indicia groove 22a and each intermediate portion 211a is significantly larger than the spacing L3 of in the conventional indicia groove 911. Deformation T1 between the face of the intermediate portion 211a and the surface 21 of the product 2 is smaller than the deformation T3 of the conventional indicia groove 911.

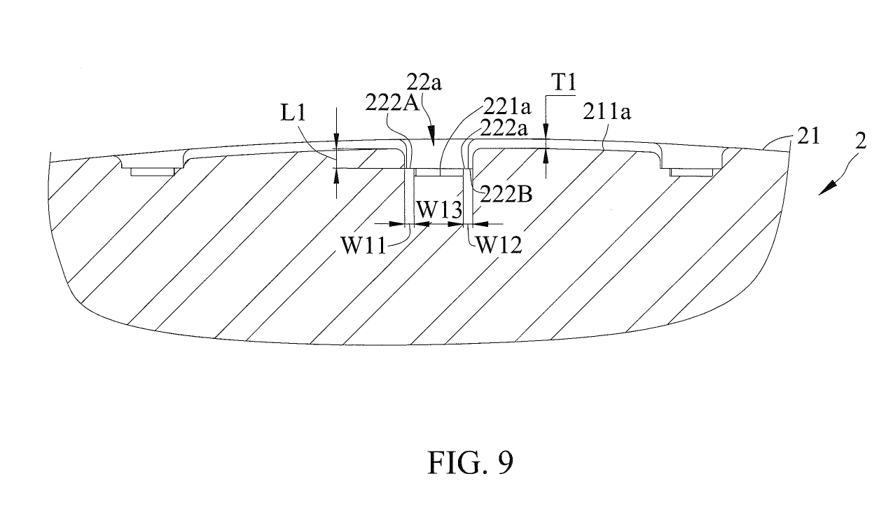

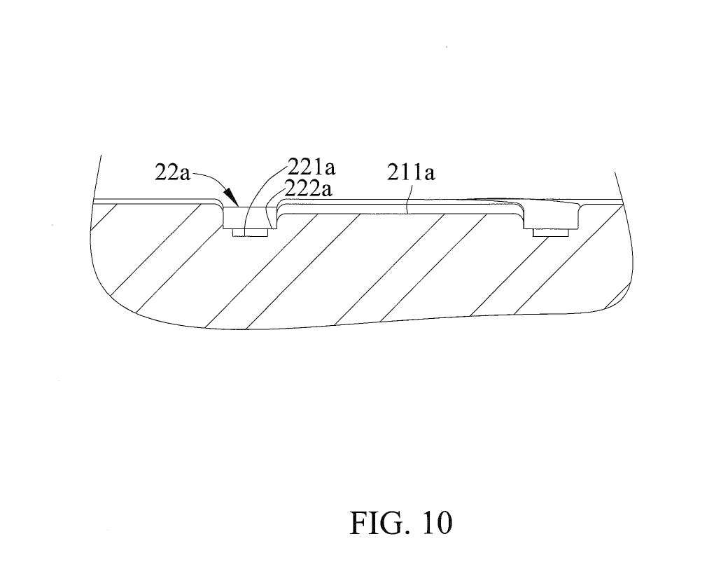

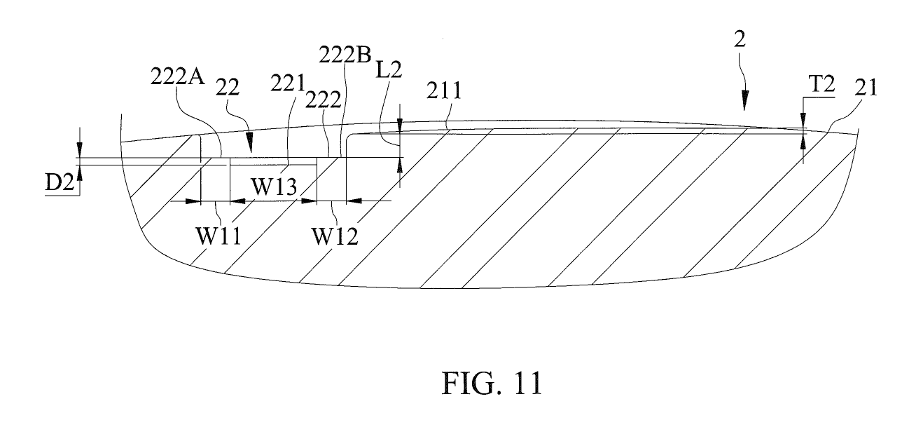

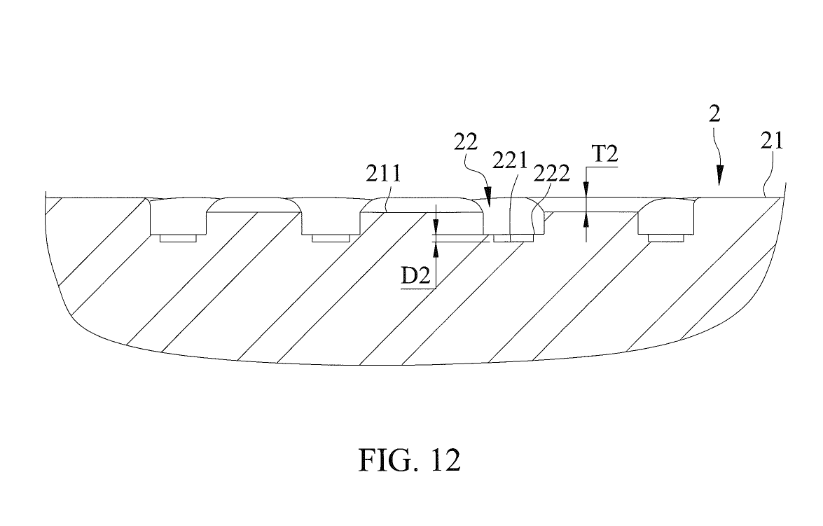

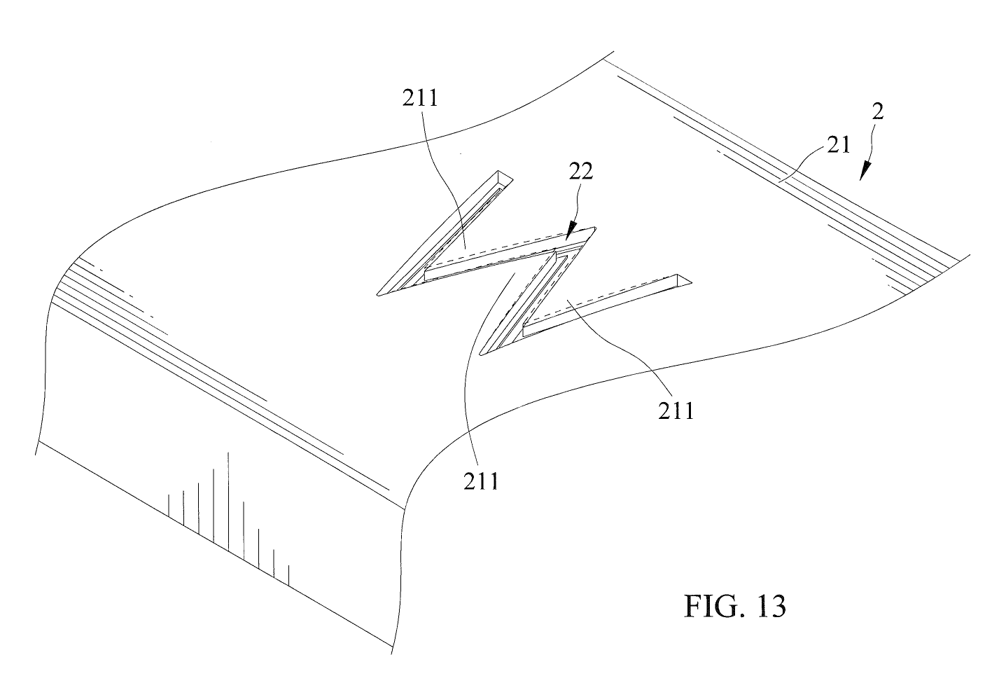

After removing the indicia dies 1 and 1a, the product 2 with a W-shaped indicia groove 22 and a B-shaped indicia groove 22a is obtained. With reference to FIGS. 9-13, the indicia groove 22 includes a bottom face 221 and a lower face 222. The lower face 222 is located between the bottom face 221 and the surface 21 of the product 2 in the height direction. Thus, the indicia groove 22 has a height difference D2 between the bottom face 221 and the lower face 222. The indicia groove 22 includes a plurality of sections. The sections of the indicia groove 22 define three intermediate portions 211 on the surface 21 of the product 2. A face of each intermediate portion 211 is spaced from the surface 21 of the product 2. Specifically, a spacing L2 between the bottom face 221 of the indicia groove 22 and each intermediate portion 211 is significantly larger than the spacing L3 of the conventional indicia groove 911. Deformation T2 between the face of the intermediate portion 211 and the surface 21 of the product 2 is smaller than the deformation T3 of the conventional indicia groove 911.

Furthermore, the lower face 222, 222a of each indicia groove 22, 22a includes first and second sections 222A and 222B on opposite sides of the bottom face 221, 221a. A sum of a width W11 of the first section 222A perpendicular to the height direction and a width W12 of the second section 222B perpendicular to the height direction is smaller than a width W13 of the bottom face 221, 221a.

By using the indicia dies 1 and 1a each having a stepped portion between the top face 131, 131a of the protrusion 13, 13a and the upper face 121, 121a of the indicia die 1, 1a, the top face 131, 131a of the protrusion 13, 13a and the upper face 121, 121a of the indicia die 1, 1a press against the surface 2 of the product 2 in sequence, such that the indicia groove 22, 22a has a height difference D2, D1 between the bottom face 221, 221a and the lower face 222, 222a.

Furthermore, due to the two-stage pressing of the indicia dies 1 and 1a, the spacing L2, L1 between the bottom face 221, 221a of the indicia groove 22, 22a and each intermediate portion 211, 211a is significantly larger than the spacing L3 of the conventional indicia groove 911. The indicia grooves 22 and 22a are, thus, very clear, providing a clear indication.

Furthermore, in a case that a paint is filled into the indicia grooves 1 and 1a for coloring purposes, the intermediate portions 211 and 211a are less likely to be colored by the paint due to the large spacing L2, L1 between the bottom face 221, 221a of the indicia groove 22, 22a and each intermediate portion 211, 211a, providing a contrast to the surface 21 of the product 2. The indicating function of the indicia dies 1 and 1a is, thus, significantly enhanced.

Although the indicia dies 1 and 1a are letters, they can be patterns or figures to provide desired indicating functions.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A method for forming an indicia groove, with the method comprising:
preparing an indicia die, with the indicia die including a pressing face, with a protruded indicia portion formed on the pressing face, with the protruded indicia portion including an upper face having a boundary, with a protrusion formed on the upper face and located in the boundary, with a stepped portion formed between the protrusion and the protruded indicia portion;
preparing a product;
pressing the indicia die against a surface of the product, forming an indicia groove in the surface of the product, with the indicia groove providing an indicating function for the product; and
removing the indicia die and obtaining the product with the indicia groove.

2. The method as claimed in claim 1, with the protruded portion having a top face, with a first height between the upper face of the protruded indicia portion and the pressing face in a height direction perpendicular to the pressing face being smaller than a second height between the top face and the pressing face in the height direction.

3. The method as claimed in claim 2, with the top face of the protrusion including a periphery, with the boundary of the protruded indicia portion having a first width perpendicular to the height direction, with the periphery of the protrusion having a second width perpendicular to the height direction, with the first width being larger than the second width, with the second width larger than a half of the first width.

4. The method as claimed in claim 1, with the indicia groove including a bottom face and a lower face, with the lower face located between the bottom face and the surface of the product, with the indicia groove having a height difference between the bottom face and the lower face.

5. The method as claimed in claim 1, with the indicia groove including a plurality of sections, with the plurality of sections of the indicia groove defining at least one intermediate portion on the surface of the product, with the at least one intermediate portion having a face, with the face of the at least one intermediate portion spaced from the surface of the product.

6. An indicia die comprising a pressing face, with a protruded indicia portion formed on the pressing face, with the protruded indicia portion including an upper face having a boundary, with a protrusion formed on the upper face and located in the boundary, with a stepped portion formed between the protrusion and the protruded indicia portion.

7. The indicia die as claimed in claim 6, with the protruded portion having a top face, with a first height between the upper face of the protruded indicia portion and the pressing face in a height direction perpendicular to the pressing face being smaller than a second height between the top face and the pressing face in the height direction.

8. The indicia die as claimed in claim 7, with the top face of the protrusion including a periphery, with the boundary of the protruded indicia portion having a first width perpendicular to the height direction, with the periphery of the protrusion having a second width perpendicular to the height direction, with the first width larger than the second width, with the second width larger than a half of the first width.

9. A hand tool comprising a surface, with an indicia groove formed in the surface of the hand tool, with the indicia groove including a bottom face and a lower face, with the lower face located between the bottom face and the surface of the product in a height direction, with the indicia groove having a height difference between the bottom face and the lower face, with the indicia groove providing an indicating function for the hand tool.

10. The hand tool as claimed in claim 9, with the indicia groove including a plurality of sections, with the plurality of sections of the indicia groove defining at least one intermediate portion on the surface of the product, with the at least one intermediate portion having a face, with the face of the at least one intermediate portion spaced from the surface of the product.

11. The hand tool as claimed in claim 9, with the lower face of the indicia groove including first and second sections on opposite sides of the bottom face, with a sum of a width of the first section perpendicular to the height direction and a width of the second section perpendicular to the height direction being smaller than a width of the bottom face perpendicular to the height direction.
